(19) United States
(12) Patent Application Publication
(10) Pub. No.: US 2007/0081117 A1
(43) Pub. Date: Apr. 12, 2007

(54) Display device and a circuit thereon

(75) Inventors: Po-Yuan Liu, Hsinchu City (TW); Sheng-Kai Hsu, Chang Hua City (TW); Kuo-Chih Lee, Tainan Hsien (TW)

Correspondence Address: BIRCH STEWART KOLASCH & BIRCH, PO BOX 747, FALLS CHURCH, VA, 22040-0747, US

(73) Assignee: AU Optronics Corp.

(21) Appl. No.: 11/517,287

(22) Filed: Sep. 8, 2006

(30) Foreign Application Priority Data
Oct. 7, 2005 (TW) 94135226

(51) Int. Cl. G02F 1/1345

(52) U.S. Cl. 349/150

(57) ABSTRACT

A display having a substrate, a plurality of pixel units, a plurality of driver chips, a group of bonding pads, a first group of wires, a second group of wires, and a flexible printed circuit film is provided. The substrate has a display area and a peripheral area. The pixel units are arrayed on the display area. The driver chips are connected in cascade and arranged on the peripheral area. The first group of wires is utilized for connecting to the group of bonding pads and two of the driver chips simultaneously. The second group of wires is utilized for connecting the driver chips in cascade. The flexible printed circuit film is utilized for connecting to the group of bonding pads and utilized for applying signals to the driver chips.

### BACKGROUND OF THE INVENTION

(1) Field of the Invention

This invention relates to a liquid crystal display (LCD) and a circuit thereon, and more particularly, to the LCD fabricated by using chip on glass (COG) technology.

(2) Description of the Prior Art

In recent years, LCDs with the advantages of slim size, low power consumption, and low radiation have been used to replace traditional cathode ray tube (CRT) displays and widely applied on various electronic devices, such as desktop computers, personal digital assistants, note books, digital camera, cell phone, and etc.

In a conventional LCD as shown in FIG. 1, large scale integration (LSI) chips 22,32 for driving pixel units in display area 10a are packaged on tape carrier package (TCP) films 24, 34 and connected to a glass substrate 10 by using tape automated bonding (TAB) technology. The printed circuit boards (PCBs) 20, 30 for laying wires are electrically connected with the devices on the glass substrate 10 through the TCP films 24,34.

FIG. 2 shows a slimmer LCD design by using the new generation chip on glass (COG) technology. The LCD fabricated by using COG technology has the LSI chips 42,52 flip-chip bonded to the bonding pads on the glass substrate 10 by using anisotropic conductive film (ACF). In contrast with the LCD fabricated by using TAB technology of FIG. 1, the TCP films 34 are saved in the present LCD.

In addition, also referring to FIG. 2, the COG technology is usually attending with wire-on-array (WOA) design to have some wires laid on the glass substrate 10 directly. Thus, the wires needed to be fabricated on the PCB 30 of FIG. 1 can be fabricated on the glass substrate 10 instead. However, it is noted that the WOA design is only commonly used for connecting the gate driver chips 52 in cascade.

In contrast with the traditional TAB technology, the COG technology can reduce the amount of TCP films 34 applied in the LCD so as to decrease the fabrication cost. In addition, the attending WOA design can simplify the design and reduce the cost of PCBs 20,30 to decrease the size and weight of the LCD and also the fabrication cost.

It should be noted that the number of the wires and the terminals laid on the glass substrate 10 by using the COG technology is restricted by the size of the peripheral area 10b on the glass substrate 10. Therefore, as shown in FIG. 2, the COG technology with the WOA design can only be applied for connecting the gate driver chips 52 with simpler function and fewer terminals in cascade.

The specific PCB 40 is still demanded for the source driver chips 42 with more complicated function and more terminals to lay the wires for transmitting signals between the source driver chips 42. The PCB 40 must provide sufficient area for the complicated circuits, generally with multi-layer design, and sufficient area for mounting a great amount of electronic components. In addition, a plurality of flexible printed circuit (FPC) films 44 are needed for electrically connecting the PCB 40 with the source driver chips 42 respectively. The cost of the complicated PCB 40 as well as the FPC films 44 restrains the attempt to further reduce the LCD fabrication cost.

Accordingly, the circuit of the LCD provided in the present invention focuses on simplifying the design of PCB and also reducing the usage of FPC films to decrease the fabrication cost. In addition, fewer FPC films means fewer electronic terminals for bonding. The reducing of the usage of FPC films may decrease the probability of poor bonding terminals so as to improve the yield and reliability.

### SUMMARY OF THE INVENTION

A circuit of an LCD is provided in the present invention. The circuit is formed on a substrate having a display area and a peripheral area, wherein the peripheral area has a plurality of regions for bonding driver chips thereon.

The circuit comprises a group of bonding pads, a first group of wires, and a second group of wires. The first group of wires is utilized for connecting to the group of bonding pads and at least two of the driver chips in different regions simultaneously. The second group of wires is utilized for connecting the driver chips in different regions in cascade.

A display is also provided in the present invention. The display has a substrate, a plurality of pixel units, and a plurality of driver chips connected in cascade. The substrate has a display area and a peripheral area. The pixel units are formed on the display area. The driver chips are connected in cascade on the peripheral area.

The driver chips are configured to receive a power signal in parallel and transmit a display control signal in cascade.

### BRIEF DESCRIPTION OF THE DRAWINGS

The present invention will now be specified with reference to its preferred embodiment illustrated in the drawings, in which:

FIG. 1 is schematic view of a conventional LCD fabricated by using TAB technology;

FIG. 2 is schematic view of a conventional LCD fabricated by using COG technology;

FIG. 3 is a schematic view of a preferred embodiment of an LCD in accordance with the present invention;

FIG. 4 is an enlarged view of a preferred embodiment of the circuit on the peripheral area of the LCD of FIG. 3; and

FIG. 5 is a schematic view of another preferred embodiment of the LCD in accordance with the present invention.

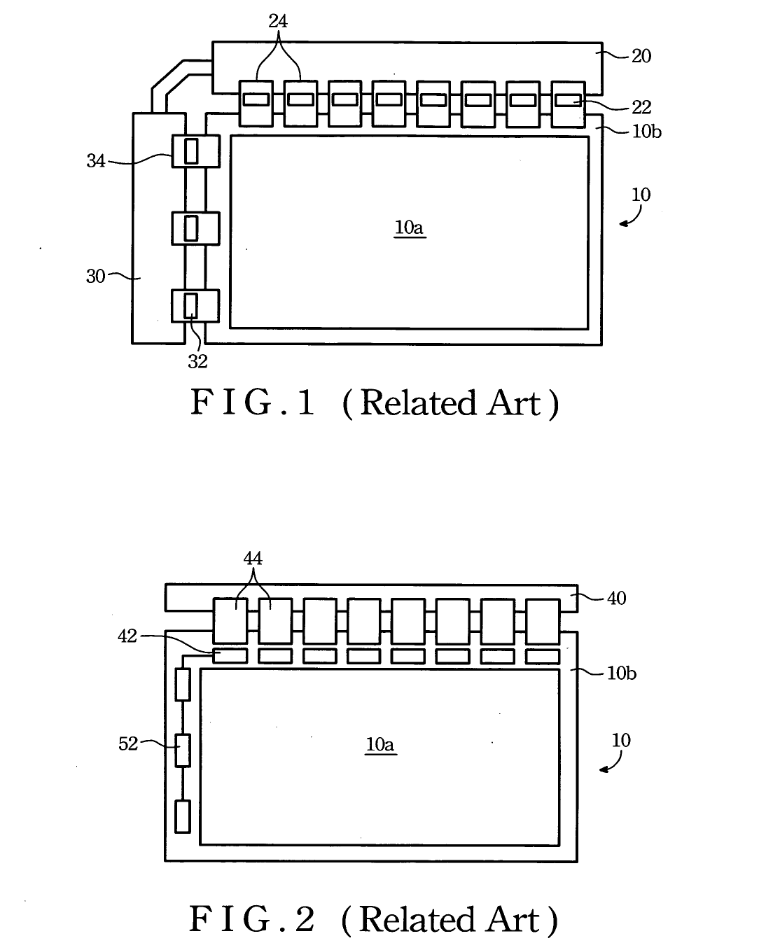

### DESCRIPTION OF THE PREFERRED EMBODIMENTS

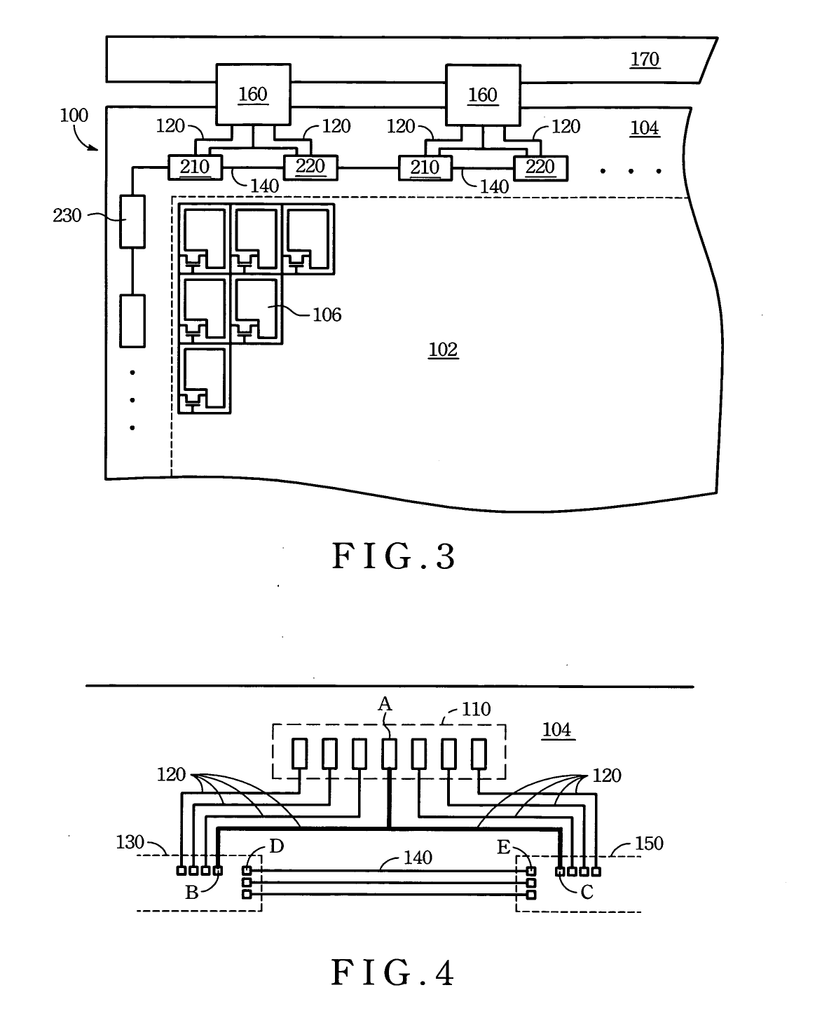

FIG. 3 shows a preferred embodiment of the LCD in accordance with the present invention. As shown, the LCD has a substrate 100, a plurality of pixel units 106, and a plurality of driver chips 210,220,230. The substrate 100 has a display area 102 and a peripheral area 104. The pixel units 106 are formed on the display area 102 in array. The source driver chips 210,220 and the gate driver chips 230 are arranged along two neighboring edges of the display area 102 on the peripheral area 104 respectively.

FIG. 4 is an enlarged view of the circuit on the peripheral area 104 with the source driver chips 210,220 being removed to show the underlying circuits. As shown, the peripheral area 104 has a plurality of regions 130,150 for bonding the source driver chips 210,220 thereon. The circuit has a group of bonding pads 110, a first group of wires 120, and a second group of wires 140.

The group of bonding pads 110 includes at least a bonding pad A connected to the connection pads B, C located in two neighboring regions 130,150 simultaneously by using the first group of wires 120. The two connection pads B, C are utilized for bonding the source driver chips 210,220 respectively. Thereby, the bonding pad A is electrically connected to the two driver chips 210, 220 simultaneously.

The both ends of one of the second group of wires 140 are connected to connection pads D and E located in the two neighboring regions 130,150 respectively. The two connection pads D, E are utilized for bonding the two source driver chips 210, 220 respectively. Thus, the second group of wires 140 can be utilized for connecting the two source driver chips 210,220 in the two regions 130,150 in cascade.

As shown in FIG. 3, a specific printed circuit board (PCB) 170 is demanded for allocating wires for applying signals to the source driver chips 210,220. In addition, a plurality of FPC films 160 is bonded at the outside edge of the peripheral area 104 forming electrical connections with the respected group of bonding pads 110. Power signals or display control signals are provided from the PCB 170 to the source driver chips 210,220 through the FPC films 160 and the group of bonding pads 110. By using the circuit provided in the present invention, the signals provided from a single FPC film 160 can be applied to at least two neighboring source driver chips 210,220 so as to save the demand of the FPC films 160.

In addition, as shown in FIG. 3, since the source driver chips 210,220 bonded on the peripheral area 104 are connected in cascade by using the second group of wires 140, the power signals or display control signals can be selectively applied to the source driver chips 210, 220 in cascade.

Ordinarily, the voltage of the power signals must be maintained so as to keep a good image displaying quality. The power signals may be includes driving voltage (VDD), common voltage (VCOM), grounding voltage (GND), and etc. The first group of wires 120 is adapted to transmit the power signal applied to the driver chips 210,220. The second group of wires is adapted to transmit the display control signals applied to the driver chips 210,220 so as to reduce the number of terminals demanded on LCD, the wires on the PCB 170, and also the FPC films 160. That is, the source driver chips 210,220 are configured to receive power signals in parallel and configured to transmit display control signals in cascade.

As mentioned, it is understood that the present invention has the advantages of simplifying the PCB 170 as well as reducing the usage of FPC films 160 by efficiently using the space between neighboring driver chips 210,220 for allocating wires. In addition, although the bonding pads 110, the first group of wires 120, and the second group of wires 140 shown in FIG. 4 are used for connecting the source driver chips 210,220, the circuit provided in the present invention may also be applied to the gate driver chips 230 on the LCD panel.

As shown in FIG. 2, the PCB 40 of conventional design needs sufficient areas for laying complicated circuits, generally with multi-layer design, and each source driver chip 42 needs a respected FPC film 44 for applying power signals and display control signals. The complicated PCB 40 and the great amount of FPC films 44 imply a higher fabrication cost. In contrast, the group of bonding pads 110 laid between neighboring driver chips 210,220 in accordance with the present invention allow the power signals provided from the FPC film 160 applied to the two driver chips 210,220 simultaneously. Therefore, it is understood that by using the blank space between the neighboring driver chips 210,220 efficiently in accordance with the present invention, the attending advantages of a simpler and smaller PCB 170 and fewer FPC films 160 are achieved so as to reduce the number of components and the fabrication cost of the LCD.

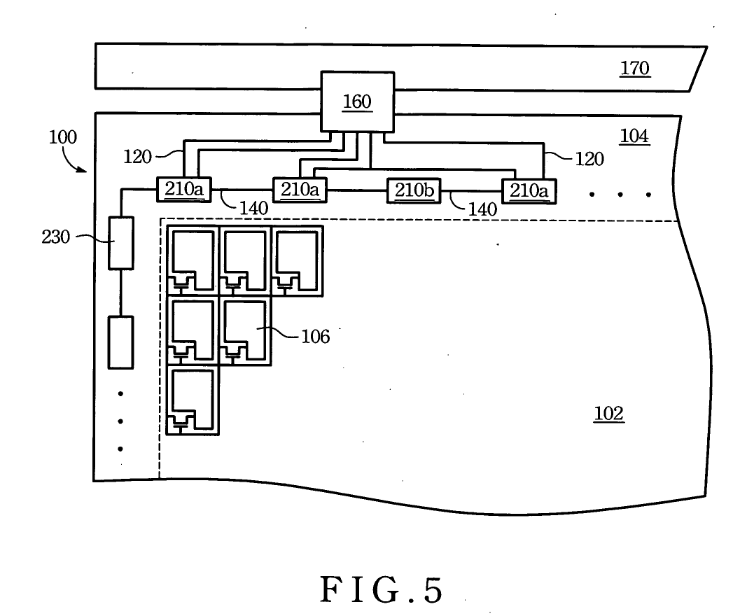

FIG. 5 shows another preferred embodiment of the LCD in accordance with the present invention. In contrast with the embodiment of FIG. 3, the present embodiment allows the signals provided from single FPC film 160 applied to more than two source driver chips 210a (three source driver chips 210a are shown in this figure). In addition, these source driver chips 210a does not have to be the nearest one with each other. For example, as shown, the source driver chip 210b without connecting to the FPC film 160 is located between the two source driver chips 210a being applied with the signals from the FPC film 160.

While the embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

What is claimed is:

1. A circuit for use in a display device formed on a substrate having a display area and a peripheral area, the peripheral area having a plurality of regions for bonding a plurality of driver chips thereon respectively, the circuit comprising:
a group of bonding pads disposed on the peripheral area;
a first group of wires connecting to the group of bonding pads and at least two of the plurality of driver chips; and
a second group of wires connecting to the plurality of driver chips in cascade.

2. The circuit of claim 1, wherein the group of the bonding pads is connected to a flexible printed circuit.

3. The circuit of claim 1, wherein the first group of wires is adapted to transmit a power signal.

4. The circuit of claim 3, wherein the power signal is a driving voltage, a common voltage, or a grounding voltage.

5. The circuit of claim 1, wherein the plurality of driver chips are source driver chips.

6. The circuit of claim 1, wherein the plurality of driver chips are gate driver chips.

7. The circuit of claim 1, wherein the second group of wires is adapted to transmit a display control signal.

8. The circuit of claim 7, wherein the display control signal is a data signal, a timing clock, a function control, or a gamma voltage.

9. A display device, comprising:
a substrate having a display area and a peripheral area;
a plurality of pixel units formed on the display area; and
a plurality of driver chips connected in cascade in the peripheral area;
wherein the plurality of driver chips are configured to receive a power signal in parallel, and the plurality of driver chips are configured to transmit a display control signal in cascade.

10. The display device of claim 9, wherein the plurality of driver chips are source driver chips.

11. The display device of claim 9, wherein the plurality of driver chips are gate driver chips.

12. A display device comprising:
a substrate having a display area and a peripheral area;
a plurality of pixel units formed on the display area;
a plurality of driver chips disposed on the peripheral area;
a group of bonding pads disposed on the peripheral area;
a first group of wires connecting to the group of bonding pads and at least two of the plurality of driver chips;
a second group of wires for connecting the two driver chips in cascade; and
a flexible printed circuit, connected to the group of bonding pads, for applying power signals to the driver chips connected to the first group of wires.

13. The display device of claim 12, wherein the second group of wires is adapted to transmit display control signals.

14. The display device of claim 12, wherein at least one of the bonding pads is electrically connected to the at least two of the plurality of driver chips.

15. The display device of claim 12, wherein the power signal is a driving voltage, a common voltage, or a grounding voltage.

16. The display device of claim 12, wherein the plurality of driver chips are source driver chips.

17. The display device of claim 12, wherein the plurality of driver chips are gate driver chips.
